(19) United States
(12) Patent Application Publication
(10) Pub. No.: US 2005/0178716 A1
(43) Pub. Date: Aug. 18, 2005

(54) Filter assembly and filter element with integral seal

(75) Inventor: Kanwar Suri, Northridge, CA (US)

Correspondence Address: PILLSBURY WINTHROP SHAW PITTMAN LLP, 725 S. FIGUEROA STREET, SUITE 2800, LOS ANGELES, CA, 90017, US

(73) Assignee: PTI TECHNOLOGIES, INC., Oxnard, CA (US)

(21) Appl. No.: 11/102,235

(22) Filed: Apr. 8, 2005

Related U.S. Application Data
(63) Continuation-in-part of application No. 10/266,225, filed on Oct. 8, 2002.

(51) Int. Cl. B01D 27/06

(52) U.S. Cl. 210/437; 210/450; 210/493.1

(57) ABSTRACT

A filter assembly for filtering fluids which may be readily disassembled includes a perforated center tube assembly and a filter element adapted to fit within a housing and slip over the perforated center tube assembly in close proximity thereto but with no physical retention means between the plastic filter element and the center tube assembly. The filter element has a unitary end cap at at least one end thereof, wherein the end cap includes a poly-elastomeric visco elastic-knife edge (VEKE) seal.

### RELATED APPLICATION DATA

This is a continuation-in-part of application Ser. No. 10/266,225, filed Oct. 8, 2002.

### BACKGROUND OF THE INVENTION

1. Field of the Invention

Embodiments of the present invention generally relate to filter assemblies and filter elements, such as those used to filter lubricants. Particular embodiments of the present invention relate to plastic filter assemblies with replaceable plastic filter elements and filter elements with unitary end caps. The invention is broadly applicable and can be used in hydraulic, fuel, air, and other filter applications.

2. Discussion of the Related Art

In order to remove contaminants from a flowing gas or liquid, the contaminated medium is often passed through a filter element. Filters are commonly used in the lubrication systems of standard internal combustion engines, e.g., automotive engines, truck or heavy equipment engines, and stationary power sources, e.g., computer numerical control CNC machines, injection molding, die cast machines, compressors, etc.

Filtration systems used in these applications generally include a cylindrical housing into which a cylindrical filter is placed to remove particulate materials from fluids such as water or air. Two types of filter assemblies have commonly been used in lubrication system applications: filter assemblies with removable filter elements and disposable filter assemblies. In a commonly-used “spin-on” disposable filter assembly, the filter element is sealed in a metal can with a metal core located in the center of the element for support structure. In such systems, to replace a clogged or dirty filter element, it is necessary to replace and dispose of the entire filter assembly.

In many filtration applications, the filter element must be changed periodically. For instance, in automotive applications, the oil filter is typically changed once every few thousand miles or every few months. There are a limited number of reusable oil filter types available or in use, but in most high quality lubrication systems, spin-on disposable filter assemblies are used, and these can create a disposal problem and are treated as hazardous material.

When filters were first introduced for use in lubrication systems, it was common to utilize cartridge type filter elements that fit into a removable housing. When the filter element needed replacement, the housing was removed from the oil filter mount on the engine, the cartridge was removed from the housing, the housing was cleaned, a new cartridge was installed, and the housing with the new cartridge was then replaced on the engine. Cartridge filters of that type usually included a cellulose filter membrane, exterior metal support, and a supporting center tube, typically of metal mesh or expanded metal. The metal supports, the center tube or outer wrap, were needed to prevent the filter from being crushed by the pressure generated in the lubricant being filtered. Differential pressures in an automotive hydraulic system can rise substantially at engine start-up, and particularly during malfunctions, such as a plugged filter malfunction (due, for example, to water or excess engine wear metals in the oil), and can reach 200 pounds per square inch (psi) or more.

Conventional practice in the past required the use of a support tube in combination with cellulose/glass fiber filters. The filter elements provided good filtering capability, and the metallic supporting structure provided the necessary rigidity and resistance to buckling due to the differential pressure between the inlet and outlet sides of the filter membrane. Disposal of the cartridge was complicated by the rigidly attached metal supporting structure that made crushing impractical and complete incineration impossible.

In more modern lubrication systems, spin-on disposable filter assemblies have been used. Spin-on disposable filter assemblies are typically more expensive, and create a greater disposal problem. However, the simplicity of removing an old filter and spinning a new one on in its place has overcome these drawbacks in many commercial applications. The spin-on filters include the typical cellulose filter elements, as well as an external shell of sheet metal, a center supporting tube, a threaded base plate, and any necessary structure to hold the filter in place and prevent it from becoming damaged. After it is used, the entire spin-on filter, including the metal shell, etc. must be discarded.

Environmental regulations, the limited availability of landfills, and a greater awareness on the part of the public with respect to landfill pollution have created the need for a filter of the type which can be safely disposed of in an environmentally acceptable way. The canister type spin-on disposable filter assemblies are problematic because they have a substantial metal content, along with the paper content, gasket content, and residual oil. Even the older variety of cartridge type filters has disposal problems, because such filters contain both metallic parts (for support) and cellulose parts (for filtering).

Attempts have been made to produce a disposable filter that is environmentally acceptable (i.e., an environmentally friendly filter), but they have also suffered drawbacks. For example, it has been proposed to utilize a filter cartridge with no metallic center support tube, and build the support tube into the filter housing. However, these approaches have been less than satisfactory for a number of reasons.

One type of spin-on filter with a replaceable/disposable filter cartridge designed to address these problems uses a radial seal as the main seal between the interior and the exterior of the filter element. However, a problem encountered when using a radial seal as the main seal involves the difficulty of disassembling the filter housing in order to change the cartridge. This type of sealing arrangement requires an unusual amount of torque to detach the cover from the housing. Even more significantly, while the center support tubes provide protection from crushing the filter elements in the radial direction, the filter element experiences significant pressure drops along its axis. Those pressure drops can be large enough to either unseat the filter and cause leakage around the main seal at one or the other end cap, or to begin to compress or crush the filter along its axis. Thus, although these filter cartridges have no metallic parts to complicate disposal, the filters themselves have significantly inferior structural properties and shorter lifespans as a result.

It is possible, by making certain compromises, to compensate for the lack of strength of an unsupported filter cartridge by using bypass valves either in the filter or in the engine. The function of a bypass valve is to respond to a pressure differential buildup caused, for example, by a plugged filter, and bypass oil around the filter. In effect, the bypass valve limits pressures in the system, but it does so at the cost of passing unfiltered oil to the equipment. However, while this might be acceptable in an automotive application, in other applications, it is completely undesirable. For example, a pressure relief valve is undesirable in those cases where passing unfiltered fluid might cause permanent damage to the machinery being protected. Typical examples are a diesel fuel system or a hydraulic system. In such systems, it is considered preferable to allow the filter to plug to protect the equipment from a catastrophic and costly failure. To withstand the pressures as the filter plugs in such systems, the filter cartridge must have adequate structural support, which eliminates the possibility of using the unsupported filter cartridges that have been available in the past.

U.S. Pat. No. 5,556,542 discloses a snap-together, all-plastic filter assembly for filtering fluids that includes a cylindrical injection-molded plastic outer shell with a closed base and an open opposite end and which defines a hollow interior which receives a filtering element and an integral injection molded plastic endplate/center tube member. The outer shell is injection molded with a pair of concentric, generally cylindrical, inner annular walls which are integral with the closed base and extend part way toward the open end of the outer shell. The filtering element which has a hollow interior fits down within the outermost of the two concentric annular walls and the center tube of the endplate/center tube member extends through the center of the filtering element and snaps in place by means of snap-fit projections which snap into snap-fit pockets disposed within the inner most of the two concentric annular walls. The filter assembly is designed as a spin-on filter and is threadedly engaged and positioned onto a mounting base, thereby completing the fluid flow path.

However, a major concern with plastic filter assemblies is the propensity of the filters to “grenade”, i.e., explode into fragments that may damage the filter element or surrounding equipment. Therefore, there is a need for a safe, environmentally-friendly lightweight filter assembly that requires replacement and disposal of only the filter element, and that is not subject to grenading.

### BRIEF DESCRIPTION OF THE DRAWINGS

FIG. 1 illustrates a cross sectional view of a filter assembly according to an embodiment of the present invention;

FIG. 2 illustrates an exploded view of the filter assembly shown in FIG. 1;

FIG. 3 illustrates a cross sectional view of a filter head according to an embodiment of the present invention;

FIG. 4 illustrates a cross sectional view of a filter bowl according to an embodiment of the present invention;

FIG. 5 illustrates a cut away sectional view of a filter element according to an embodiment of the present invention;

FIG. 6 illustrates a cross sectional view of filter end caps according to an embodiment of the present invention;

FIG. 7 illustrates an enlarged view of a VEKE-Seal between a filter end cap and a head portion of a filter assembly according to an embodiment of the present invention;

FIG. 8 illustrates an enlarged view of a VEKE-Seal between a filter end cap and a base portion of a filter assembly according to an embodiment of the present invention;

FIG. 9 illustrates a cross sectional view of a center tube assembly (CTA) according to an embodiment of the present invention;

FIG. 10 shows an exploded left-side view of a filter element-CTA combination according to an embodiment of the present invention;

FIG. 11 shows an exploded right-side view of a filter element-CTA combination according to an embodiment of the present invention; and

FIG. 12 shows an exploded view of another filter assembly according to an embodiment of the present invention.

### DETAILED DESCRIPTION

The present invention is directed to a multi-media filtration system adaptable to a standard “spin-on, spin-off” design, and which may be capable of separating particles at the micron and sub-micron level, yet provides the convenience of a replaceable filter element adaptable to a filter head, filter block, or filter cavity in which all of the components may be reused except for any disposable filter element.

Embodiments of the present invention may incorporate a reusable center tube support that serves to position the filter element within the filter housing and/or to support the filter element against the hydraulic pressures being imposed by the fluid being filtered so as to minimize buckling, collapse, or blow-through and to isolate the filter element from other internal forces. Furthermore, in embodiments of the present invention, a plastic bowl may be designed to burst in a predictable manner at a predetermined position without grenading.

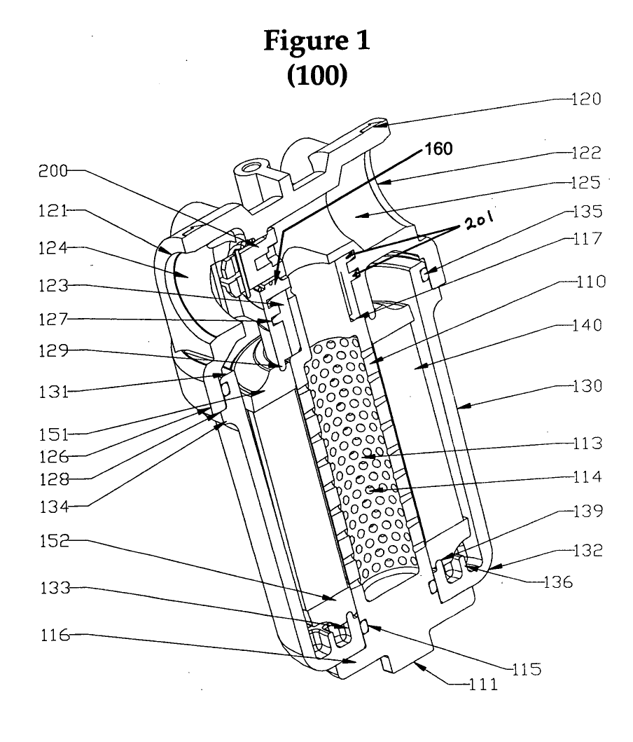

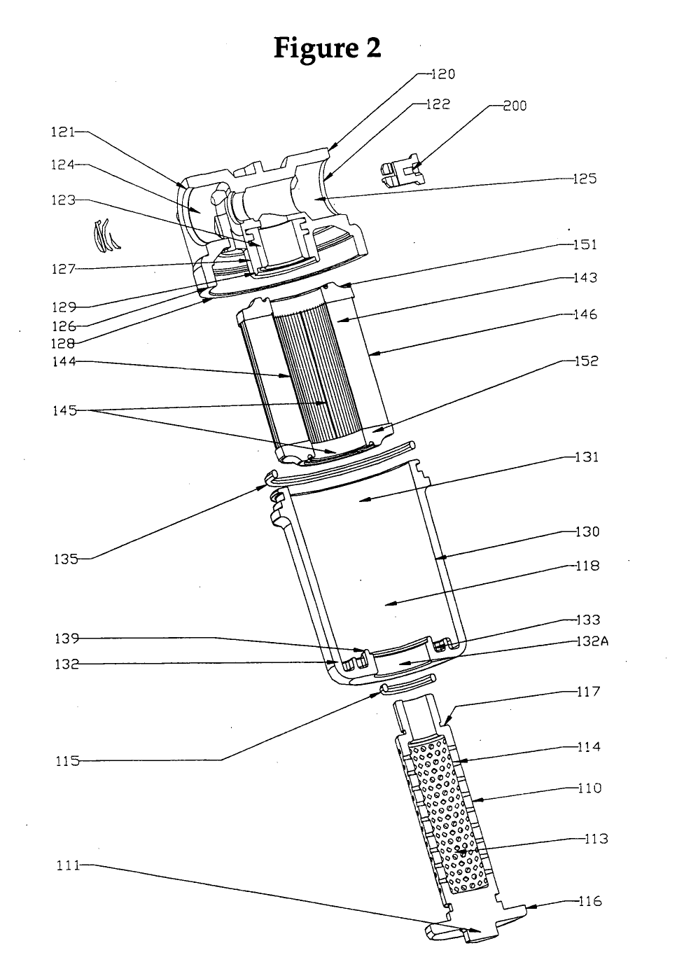

FIG. 1 illustrates an embodiment of a filter assembly according to the present invention. Filter assembly 100 includes a removable coreless filter element 140 for filtering fluids. The filter assembly 100 may be readily disassembled and includes a center tube assembly (CTA) 110. The CTA 110 may be sealingly connected at one end to a head 120 and is closed and terminated at its opposite end by a base structure 111. A conduit portion of the CTA 110 may be perforated 114 and the filter element 140 may be disposed around this portion of the CTA 110. The CTA 110 and filter element 140 are contained within a bowl 130 when assembled to head 120. FIG. 2 illustrates an exploded view of the filter assembly 100 according to an embodiment of the present invention.

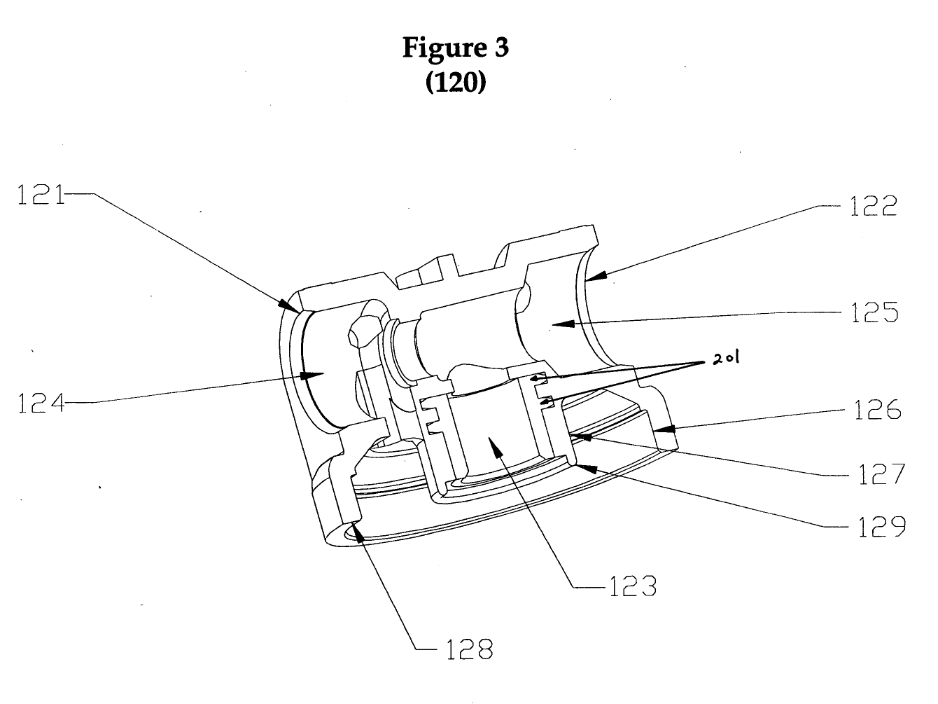

FIG. 3 illustrates a cross sectional view of the head 120 according to an embodiment of the present invention. The head 120 may be unitary and may be formed from an injection-molded plastic. The head 120 also includes a unitary steel threaded insert 123 having at least one flange 201, and may be injection molded with the plastic of head 120. As will be discussed in more detail below, with the flange(s) 201, the threaded insert 123 has a larger bearing surface and, as such, bears and also uniformly spreads the load generated by the pressurized bowl 130 over a larger contact area, thus maximizing the load applied to the head 120. The metallic material of which the insert 123 is manufactured is generally selected to have higher strength properties than the properties of the plastic resin used for molding the head 120.

The head 120 may also include a fluid inlet passage 124 through which an unfiltered fluid is provided at the inlet side of the filter element 140, a fluid outlet passage 125, and a bypass valve 200 (see FIG. 1).

With reference to FIGS. 1 and 3, the head 120 may also include fittings 121, 122 that may be formed above an exterior annular wall 126 forming an annular base structure. Fitting 121 allows attachment to a fluid supply whereby unfiltered fluid may flow from the fluid supply through the fluid inlet passage 124 into the bowl 130 and through the filter element 140. Filtered fluid may flow out of the filter element 140 into the perforated portion 114 of the CTA 110 and out of the filter assembly 100 through the fluid outlet passage 125 in the head 120 and into a return line attached to fitting 122. Fittings 121, 122 may be any type of fluid-tight seal coupling mechanism. However, injection molded threaded fittings are preferred. The head 120 may also include one or more integral threaded ports 160 for mounting additional devices, e.g., a differential pressure indicator, a flow meter, and a temperature gauge.

The head 120 may further incorporate an interior annular wall 127 unitary with the head 120 and extending axially and concentric with the central/longitudinal axis of the filter assembly 100 and/or the CTA 110. The inner surface of the interior annular wall 127 may mate with the metal insert 123 (and flanges 201). The interior annular wall 127 may be disposed outside of the CTA 110. The interior annular wall 127 may include a “knife” edge 129 to form a fluid-tight seal with a first end cap 151 of the filter element 140.

The head 120 may further include an exterior annular wall 126 having a shoulder 128 that may provide a fluid-tight seal between the head 120 and an open end 131 of the bowl 130.

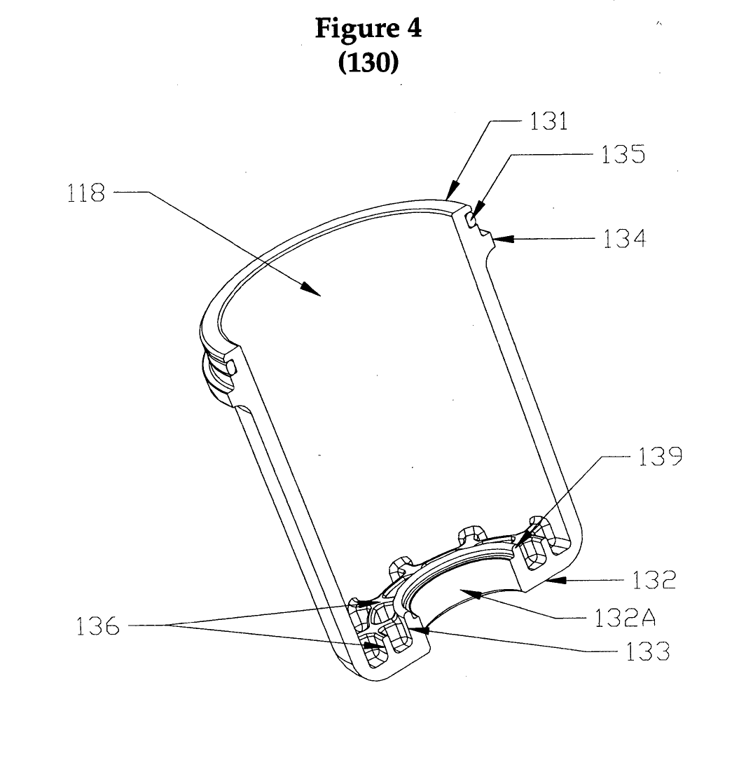

FIG. 4 illustrates a cross sectional view of the filter bowl 130 according to an embodiment of the present invention. The bowl 130 may have an open end 131, a hollow interior 118, and a base 132 opposite to the open end 131. The bowl 130 may be unitary and may be formed from an injection molded plastic. The base may have an opening 132A through which the CTA 110 may be inserted into the filter assembly 100.

With reference to FIG. 1 and FIG. 4, the bowl 130 may include an interior annular wall 133 that is unitary with the bowl and extends into the hollow interior 118 from the opening 132A of base 132 toward the open end 131. The bowl 130 may also include an annular flange 134 that may abut the shoulder 128 of the exterior annular wall 126 of the filter head 120 when the filter element 140 is installed, and a radial seal 135 located around the open end 131 of the bowl 130 for slidingly forming a fluid-tight assembly with the exterior annular wall 126 of the head 120. The bowl 130 further includes integral interior structural ribs 136 located on the interior surface of the base 132. The interior annular wall 133 may include a knife edge 139 to form a fluid-tight seal with a second end cap 152 of the filter element 140.

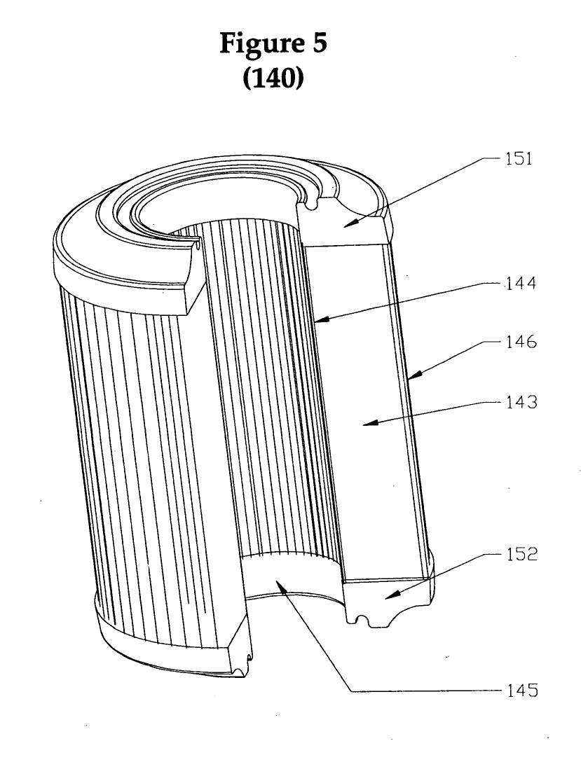

FIG. 5 illustrates a disposable cylindrical filter element 140 according to an embodiment of the present invention. The disposable cylindrical filter element 140 may have a first end cap 151 sealed to its upper end, and an opposing second end cap 152 sealed to its lower end, so as to be unitary therewith. The filter element 140 may also have a hollow internal chamber 145 through which the CTA 110 may pass. The first end cap 151 and the second end cap 152 prevent fluid flow from flowing through the ends of the filter element 140, and help separate the outlet side of the filter element 140 from the inlet side.

The filter element 140 may use a poly-elastomeric material for the end caps 151, 152, which gives structural integrity to the element pack and also provides a positive seal to the head 120 and base 132 of the bowl 130 via the knife edges 129 and 139. Thus, each of the first end cap 151 and second end cap 152 may include a poly-elastomeric visco elastic-knife edge (VEKE) seal, which eliminates the need for conventional seal arrangements such as a face seal or O-ring.

The filter element 140 includes a filtration medium 143 arranged in a cylinder and defining an inner cylindrical wall 144 forming the internal chamber 145 and an outer periphery 146 that is also cylindrical. The filter element 140 may be configured so that it contains no supporting center tube that must be discarded with the media. The filtration medium 143 may be plastic and formed by a conventional pleated construction. Other forms of filter media are also usable.

The disposable center tube-free construction, along with the end cap construction (to be described below) which are of environmentally-acceptable disposable materials, provide for a filter element which, after use, can be readily discarded. As one alternative, for example, filter element 140 can be incinerated, since it contains no toxic materials and no non-incineratable metal. As a further alternative, the filter element 140 can be crushed, which not only removes oil residue, but also substantially reduces the volume. The filter element 140, after being crushed to remove oil and reduce its volume, can be incinerated or deposited in a landfill. The disposable center tube-free construction is of significance in both of the alternatives for filter disposal.

For the purpose of securing and sealing the ends of the filter, end caps 151, 152 form continuous ring-like discs secured to the filtration medium 143 at each end of the filter. The end cap material is preferably incineratable without creating toxic substances, and is also suitable for landfill disposal. A poly-elastomeric compound is a preferred material, configured as a molded poly-elastomeric ring.

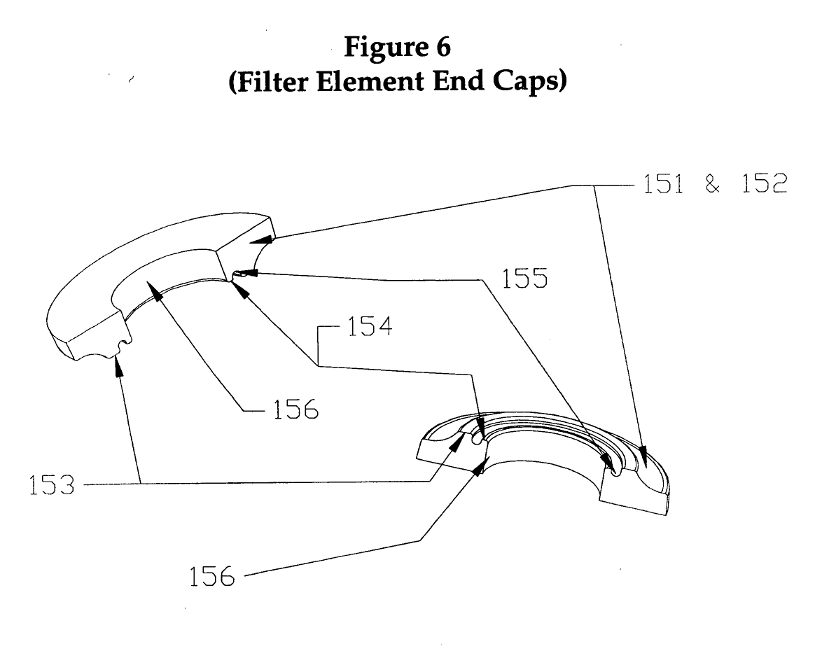

FIG. 6 illustrates the end caps 151, 152 in the form of a visco elastic-knife edge seal (VEKE-Seal) according to a preferred embodiment of the present invention. The end caps 151, 152 are manufactured from visco-elastic, a poly-elastomeric compound, formed in a molding operation in which the visco-elastic compound attaches to the pleats of the filtration medium 143. The visco-elastic compound is a soft compound which flows easily into a mold, deforms easily, and is compatible with hydraulic fluid, compressor oil, transmission oil, motor oil, etc. Visco-elastic has a 75 shore A durometer measurement to replicate the effect of a conventional O-ring.

Visco-elastic is a cross-linked thermoset polymer that is classified as a polyurethane, consisting of 100 parts of polyester polyol and 30 parts of Isocyanate. The basic polyurethane includes a compound with hydroxyl groups (i.e., polyols) which, when reacted with Isocyanate, forms polyurethane. When both polyol and Isocyanate have a functionality of two or more, a cross-linked network, which is “thermoset” in nature, forms. Visco-elastic has a high transmission fluid resistance with a minimal weight increase (1.4% weight increase when soaked in Trasmax S (Lot# M8121) @ 250° F. for 72 hours). Experimentation with a polyoxypropylene glycol, castor oil, and Isocyanate based polymer (22.6% weight increase when soaked in Trasmax S @ 250° F. for 72 hours) and a hydroxyl terminated polybutadiene and Isocyanate based polymer (40.1% weight increase when soaked in Trasmax S @ 250° F. for 72 hours) resulted in an incompatibility with transmission fluid.

In a preferred embodiment of the present invention, the end caps 151, 152 are formed of the moldable visco-elastic compound. The visco elastic-knife edge seal (VEKE-Seal) end caps deliver a better overall seal out or sealant effect. The end caps 151, 152 may be made of another material, preferably a moldable elastomeric potting compound such as polyurethane, an epoxy, plastisol or another moldable, flexible material.

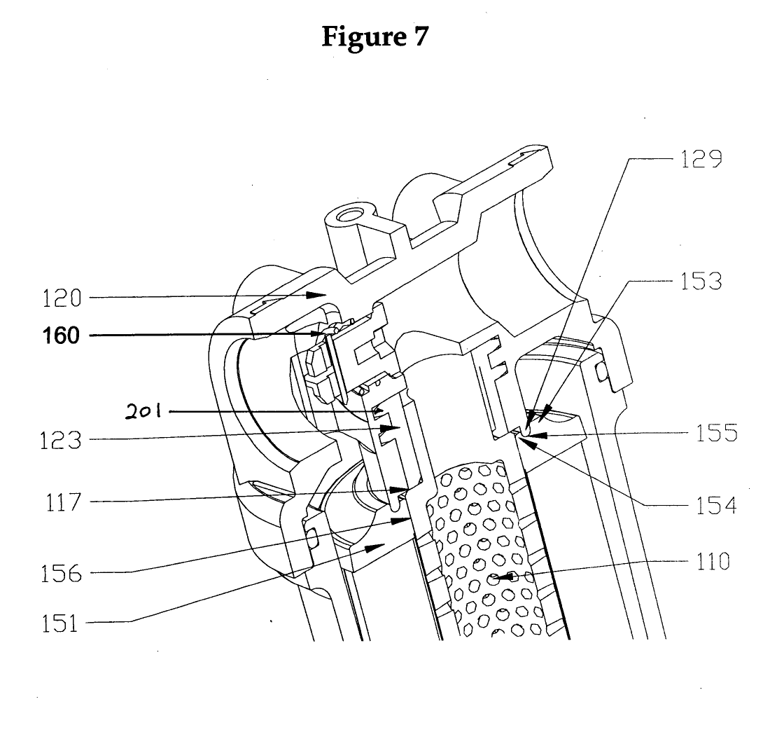

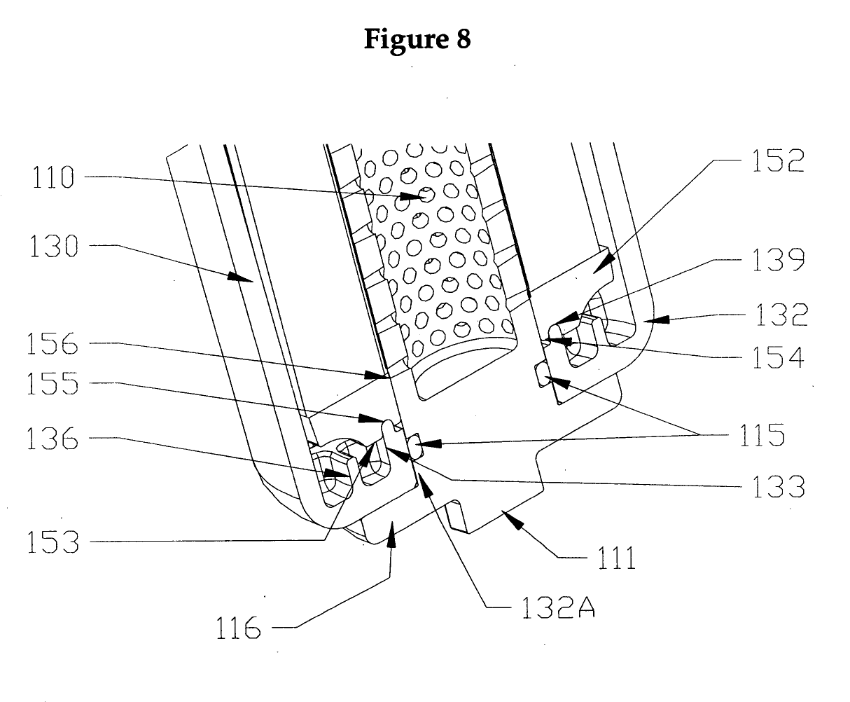

The structure and corresponding functionality of the VEKE-Seal end caps 151, 152 will now be more fully described with reference to FIG. 7, illustrating an enlarged view of the VEKE-Seal end cap 151 to head 120 interface of the filter assembly 100, FIG. 8, illustrating an enlarged view of the VEKE-Seal end cap 152 to base 132 of bowl 130 interface of the filter assembly 100, and the cross-sectional views of FIGS. 1, 5, and 6. The VEKE-Seal end caps 151, 152 include radial, axially-extending protrusions 153 and 154 which form a pocket 155 to receive the knife edges 129, 139, respectively, of the head 120 and base 132 of bowl 130. The potting operation partly encapsulates the margins of the pleated filtration medium 143. By virtue of the former connection, the VEKE-Seal end caps 151, 152 are securely fixed to the pleats, and therefore hold the shape of the filter 140.

The “knife” edges 129, 139 preferably have a rounded or beveled nose to facilitate mating with the VEKE-Seal end caps 151, 152 of the filter element 140. VEKE-Seal end caps 151, 152 may also include a substantially flat sealing surface 156. The sealing surface 156 forms a continuous cylindrical surface sized and adapted to mate with the outside of CTA 110.

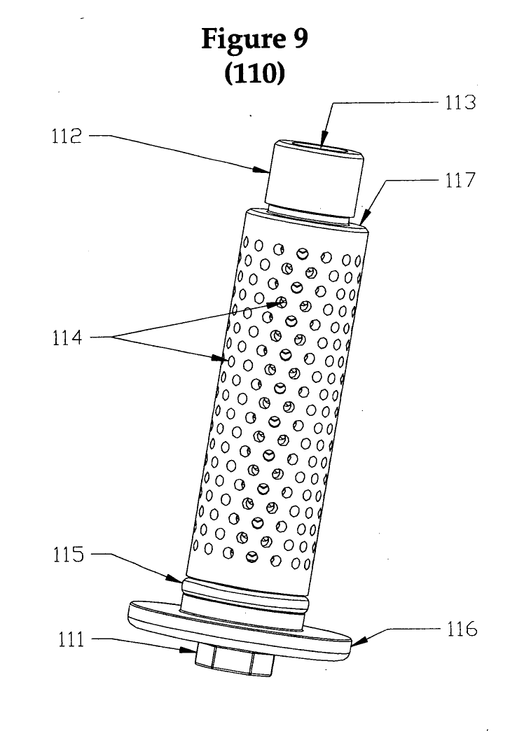

FIG. 9 illustrates the CTA 110 according to an embodiment of the present invention. The CTA 110 may be unitary and made of metal, and may have a base 111 in opposing relation to a threaded top portion 112. The base 111 may be formed in various shapes, such as, e.g., a hexagonal shape, and may include a flange 116. The CTA 110 may also include a central flow passage 113, a plurality of fluid flow perforations 114, and a radial seal 115. Referring to FIG. 8, the radial seal 115 defines a friction interfit that sealingly engages the CTA 110 and the annular wall 133 when the CTA 110 is inserted through the opening 132A in the base 132 of the bowl 130.

Referring to FIG. 1 through FIG. 9, the disposable cylindrical filter element 140 is adapted to fit within the bowl 130 and adapted to slip over the perforated CTA 110 in close proximity thereto but with no physical retention mechanism between the filter element 140 and the CTA 110. The CTA 110 may extend through the hollow internal chamber 145 of the filtering element 140 and threadedly attach to the threaded metal insert 123 in the head 120, thus forming a fluid-tight connection with the fluid outlet 125 and securing the CTA 110, the filtering element 140, and the bowl 130 to the head 120. The CTA 110 may incorporate a shoulder 117 that seats against the threaded metal insert 123 in the head 120 to prevent overtightening of the CTA 110/insert 123 interface.

The head 120, bowl 130, and/or filter element 140 may be made of a high strength engineered plastic which is lighter and less expensive than metals with similar strength, cost, and corrosion properties. A plastic head 120 may be used with an injection molded metal insert 123. The CTA 110 may screw into this metal insert 123, thus ensuring correct alignment of all parts, as well as hydraulic integrity between the bowl 130, the head 120, and the filter element 140. This metal insert 123 may also prevent the threaded top portion 112 of the CTA 110 from stripping out associated plastic threads in the head 120 during cyclic impulse loading, i.e., fatigue.

The CTA's shoulder 117 may bottom out against the face of the metal insert 123 during coupling of the filter element 140 and bowl 130 into the head 120. This prevents over-tightening of CTA 110 into the head 120, which would otherwise cause structural damage to the plastic bowl 130.

The radial seal 115 interface at the bottom of the CTA 110 and the bottom of the bowl 130 may perform two important functions: (1) perfectly sealing the interface between the plastic bowl 130 and the CTA 110 during thermal excursions (temperature cycling from hot to cold and vice versa) even with the mismatch of the thermal coefficients of expansion between plastic and metal; and (2) providing sufficient friction between the CTA 110 and the bottom of the bowl 130 to prevent the CTA 110 from dropping out when the bowl 130 is removed from the head 120.

Prior reluctance to use plastic bowls is due to the fact that plastic “grenades” when it hydraulically bursts at high pressure, sending plastic shrapnel in all directions. To overcome this problem, the head 120 and bowl 130 may be made from, e.g., Stanyl TW241F10, a fatigue rated glass-filled plastic manufactured by DSM Manufacturing, that can endure 1 million fatigue cycles from 0 to 200 back to 0 psig. Furthermore, the filter design is unique in that it will burst in a predictable manner at a predetermined position without grenading.

More specifically, during operation, unfiltered fluid flows into the head's inlet passage and downwards into the plastic bowl 130. Thus, once pressurized, the bowl 130 starts to deform. As the internal pressure increases, the bowl's base rotates around the periphery, or outer corner, of the flange 116. This, in turn, causes material near the conduit portion of the CTA 110 to separate from the conduit as the diameter of the opening 132A in the bowl's base increases. As the opening 132A enlarges, high stresses are generated around the bottom of the annular wall 133, and the bowl cracks in (or near) that location. Thus, with reference to FIGS. 4 and 8, the plastic bowl 130 will burst (under sufficient pressure) at the interior annular wall 133 allowing the full force of the resulting high-pressure spray (during burst) to be deflected away from personnel by the flange 116.

However, in order for the bursting (i.e., fracture/failure) to occur in a predictable manner and location as discussed above, the vertical clearance between the bowl's base 132 and the flange 116, as well as the relative dimensions of the flange 116, the bowl's base 132, and the opening 131A, must be optimized such that the bowl 130 and the CTA 110 can move relative to each other and, if necessary, separate. An additional factor in this optimization may be the contact region between the conduit and the annular wall 133.

The vertical clearance between the bowl's base 132 and the flange 116 prevents pre-loading of the bowl 130 (i.e., interference fit between the bowl and the CTA). This is important because, if the bowl is preloaded, then the bowl and the CTA act as one piece, which will result in premature failure of the bowl in an unpredictable manner and/or unpredictable location. In this respect, it has been determined that vertical clearances in the range 0.005-0.030 inch yield optimum results.

Similarly, experimental results indicate that optimum results may be attained when the dimensions of the outer diameter of the bowl's base (OD), the diameter of the opening 132A in the bowl's base (ID), and the diameter of the CTA's flange (D) are related by the following formula:
D=ID+k(OD−ID),
where k is a constant and 0.10≦k≦1.0.

The base 132 of the bowl 130 may also have integral structural ribs 136 which make the bowl 130 lighter (and less expensive) while optimizing the uniformity of the cooling of the hot-“as injected” unit. This uniformity of cooling minimizes residual stresses in the bowl 130. As a result, a plastic bowl 130 may have a strength approaching that of a cast aluminum bowl. Many samples of the bowl 130 were burst tested at 1400 psi at 200° F.

The head 120, the bowl 130, and/or the filter element 140 may be made of a high strength engineered plastic that may also be manufactured in various colors. This enables manufacturers to use various visual combinations in order to custom color code their filter assemblies.

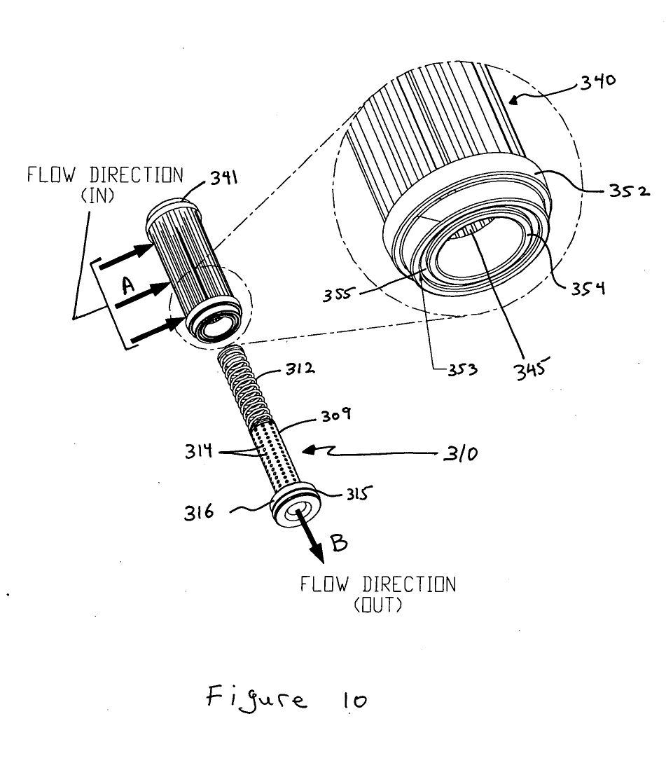

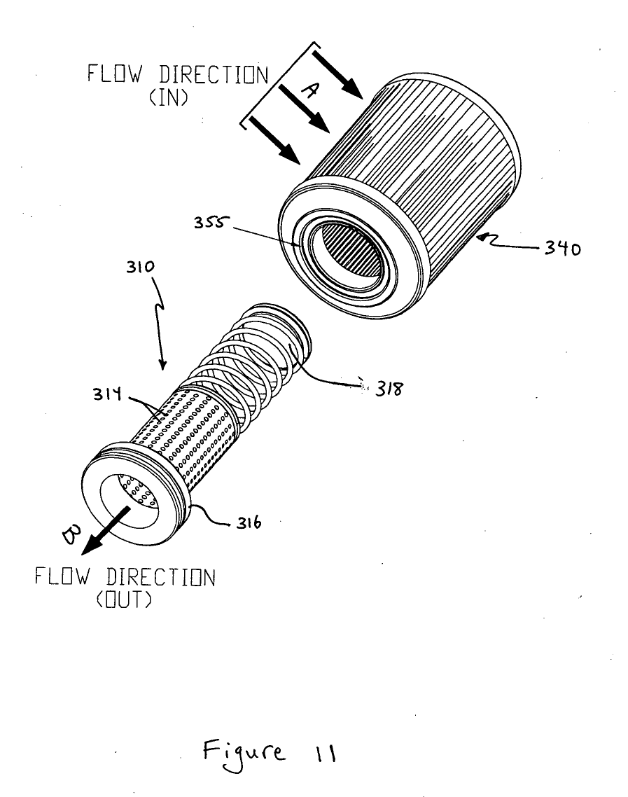

In another embodiment shown in FIGS. 10-12, the CTA 310 includes an annular base 316 and a central flow passage that includes a conduit 309 having perforations 314 through the periphery thereof. The base 316 and conduit 309 may generally be constituted as a unitary piece, such that, at its bottom end, the conduit 309 merges with the base 316.

At its upper end, the conduit 309 is coupled to a spring member 312, which coupling may be achieved by any means known in the art, including welding or using appropriate adhesives. At its opposite end, the spring 312 is closed off by a solid cap 318.

As discussed previously in connection with other embodiments of the present invention, the CTA 310 is configured to be inserted within a filter element 340. As shown in FIG. 10, at its lower end, filter element 340 includes, and is unitary with, (an upper surface of) an annular end cap 352. However, in contrast to the previously-described embodiments, at its upper end, the filter element 340 is closed off with a solid cap 341.

The filter element 340 is generally cylindrical and defines a longitudinal hollow center portion 345 therethrough. In addition, on its lower surface, the annular end cap 352 includes a pair of radial, axially-extending protrusions 353, 354 that form a pocket 355 therebetween. As in the other embodiments discussed above, the pocket 355 is sized so as to receive a mating knife edge to form a fluid-tight seal. More specifically, the annular base 316 of the CTA 310 includes a radial, axially-extending protrusion 339 that is formed on, and is generally unitary with, the upper surface of the base 316.

In operation, the CTA 310 is inserted into the filter element's hollow center portion 345 such that the spring member 312 is pressed against the filter element's solid cap 341. Upon continued pressing, the knife edge 339 on the upper surface of the CTA's base 316 matingly engages the recessed pocket 355 that is formed on the lower surface of the end cap 352 and, thus, forms a fluid-tight seal between the filter element 340 and the CTA 310.

Although the above-described embodiment may be utilized in any filtration application, it finds particular use in applications where only a limited amount of space is available for implementation of the filtration application. Thus, while the filter assembly described above may be used in conjunction with at traditional “bowl”, its advantages may be more apparent in situations where a pre-defined cavity, or housing, already exits, within which the filtration operation must be accomplished. In such situations, it is not always possible to use a traditional filter assembly, or even a filter assembly as described in FIGS. 1-9 herein, because the very limited amount of space that is available within the cavity makes it impractical, if not impossible, to manually reach into the cavity in order to remove and replace a used filter element.

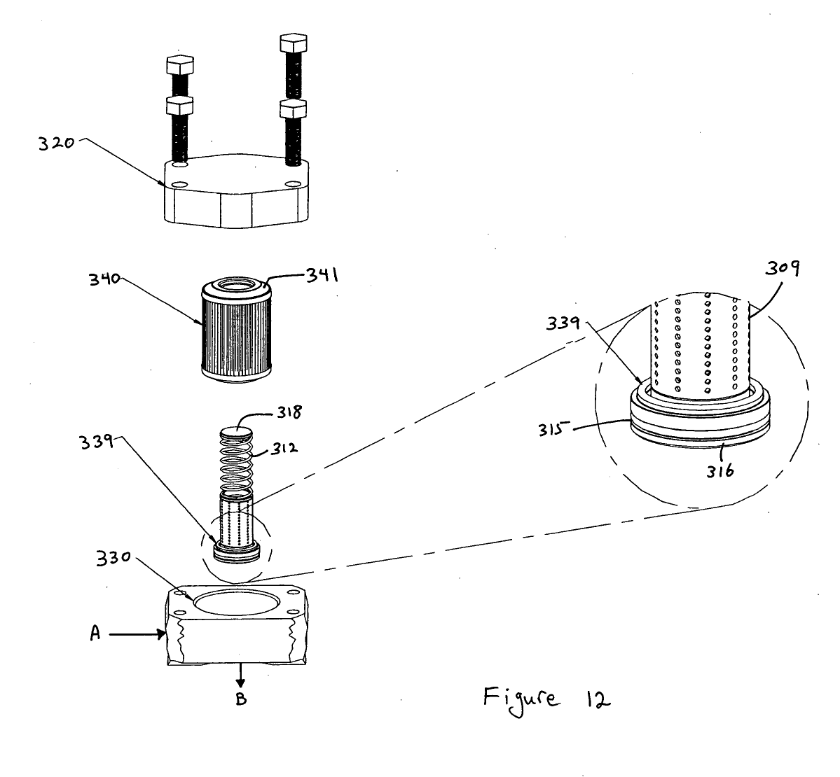

With the above in mind, and with reference to FIG. 12 as an illustrative example, this embodiment of the present invention provides a solution whereby the CTA-filter element combination is placed into a cavity 330, pressed down, and the cavity 330 closed off with a cover, or head, member 320. In this manner, when replacement of the filter is needed, the cover member 320 is simply removed, at which time the filter element “pops out” as the spring member 312 expands. Once the filter has been changed, the cover member is replaced.

It is also noted that the CTA base 316 includes a radial seal 315 for effecting a sealed engagement between the radially outer surface of the CTA base 316 and the cavity, or housing 330, thus separating the filter assembly's fluid inlet from the fluid outlet. Therefore, in operation, fluid may enter the housing (e.g., laterally; see Arrows A), flow through the filter element 340 and the perforations in the conduit 309, travel through the CTA's annular base 316 (see Arrows B), and then out through (e.g., an underside) of the housing 330.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

1. A filter element for filtering a fluid, said filter element comprising:
an inlet side, an outlet side, a top end, a bottom end, and a filtration medium extending between said top and bottom ends and separating said inlet side from said outlet side; and
a first end cap coupled to one of said top or bottom ends, wherein the end cap is a poly-elastomeric annular disc and has a first surface that forms a seal with said filter end such that the end cap is unitary with the filter end and a second surface opposite to said first surface, said second surface having first and second radial, axially-extending protrusions to form a recessed pocket therebetween, said pocket being configured to form a fluid-tight seal with an external, mating knife edge.

2. The filter element of claim 1, wherein the filtration medium is a pleated membrane.

3. The filter element of claim 2, wherein the poly-elastomeric annular disc is formed from a poly-elastomeric compound in a molding operation in which the compound attaches to the pleats of the membrane so as to become unitary with the filter element.

4. The filter element of claim 1, wherein the poly-elastomeric annular disc is made from a viscoelastic polyurethane to form a viscoelastic-knife edge seal (VEKE-Seal).

5. The filter element of claim 1, wherein the filter element is configured to be contained in a housing, and said external, mating knife edge is unitary with said housing.

6. The filter element of claim 1, wherein the filter element is cylindrical and defines a longitudinal hollow center portion therethrough, the filter element being adapted to receive a center tube assembly (CTA) within said center portion, and said CTA including a base and a central flow passage that includes a longitudinal conduit having a plurality of fluid flow perforations through the periphery thereof.

7. The filter element of claim 6, wherein the filter element is configured to be contained in a housing, and the CTA's base includes a radial seal for sealingly engaging a radially outer surface of said CTA with said housing.

8. The filter element of claim 6, wherein the CTA's base includes an upper surface and a lower surface, and said external, mating knife edge is a radial, axially-extending protrusion that is formed on said upper surface of the CTA's base.

9. The filter element of claim 8, wherein said first end cap is unitary with the filter element's bottom end, the filter element's top end is closed off with a solid cap, and the CTA's longitudinal conduit is attached, at one end, to the CTA's base and, at an opposite end, to a spring member such that, when the CTA is inserted into the filter element's hollow center portion and the spring member is pressed against said solid cap, the knife edge on the upper surface of the CTA's base matingly engages the recessed pocket on the first end cap's second surface so as to form a fluid-tight seal between the filter element and the CTA.

10. A filter assembly comprising:
a hollow plastic bowl having an open upper end and a semi-closed base, said base defining an opening through the center thereof, and said bowl further including an annular wall that is unitary with said bowl and extends axially into the bowl's hollow interior from said opening in the semi-closed base;
a filter element defining a longitudinal hollow center portion therethrough and being disposed within the hollow interior of the bowl;
a plastic head including a fluid inlet passage and a fluid outlet passage and configured to be coupled to the bowl's upper end; and
a center tube assembly (CTA) including a base and a central flow passage that includes a longitudinal conduit, said conduit having a plurality of fluid flow perforations and being unitary with the CTA's base at its bottom end and having a threaded portion at its top end, wherein:
the conduit is configured to extend through the opening in the bowl's base and through the hollow center portion of the filter element and threadedly attach to the head so as to secure the CTA and the bowl to the head; and
the CTA's base includes a flange that is disposed a vertical distance of 0.005-0.030 inch below the bowl's base and is sized to allow the bowl's base to rotate around the periphery of the flange such that, when fatigued, the radially inner surface of the annual wall deflects away from the conduit, thereby causing the bowl's base to fracture at the annular wall.

11. The filter assembly of claim 10, wherein the dimensions of the outer diameter of the bowl's base (OD), the diameter of the central opening in the bowl's base (ID), and the diameter of the CTA's flange (D) are related by the formula D=ID+k(OD−ID), where k is a constant and 0.10≦k≦1.0.

12. The filter assembly of claim 10, wherein the CTA's flange is sized such that, when the bowl's base fails, the fracture propagates radially outwards, and the resulting high-pressure spray is deflected away by the flange.

13. The filter assembly of claim 10, wherein the bowl includes a radial seal towards its upper end for slidingly forming a fluid-tight assembly with the head.

14. The filter assembly of claim 10, wherein the CTA further includes a radial seal for sealingly engaging a radially outer surface of the CTA and a radially inner surface of the annular wall.

15. The filter assembly of claim 10, wherein said filter element includes an upper end and an axially opposite lower end, said upper and lower ends being sealed closed by respective upper and lower elastomeric end caps.

16. The filter assembly of claim 15, the head further including a second annular wall unitary with the filter head and extending axially and concentric with the center/longitudinal axis of the filter assembly, wherein a lower end surface of the second annular wall includes a knife edge that matingly engages the filter element's upper end cap to form a fluid-tight seal.

17. The filter assembly of claim 16, wherein the bowl's annular wall has an upper end surface that matingly engages the filter element's lower end cap to form a fluid-tight seal.

18. The filter assembly of claim 17, wherein each of the end caps includes first and second radial, axially-extending protrusions to form a recessed pocket therebetween, each said pocket being configured to matingly engage with a respective one of the knife edges to form said fluid-tight seal.

19. The filter assembly of claim 10, wherein the head is unitary and made from a Fatigue Rated Glass Filled Plastic material.

20. The filter assembly of claim 10, wherein the head includes an annular threaded metal insert, said insert having at least one transverse flange.

21. The filter assembly of claim 20, wherein the CTA further includes a shoulder that seats against the metal insert in the head.

22. The filter assembly of claim 20, wherein the head further includes a second annular wall unitary with the filter head and extending axially and concentric with the center/longitudinal axis of the filter assembly, the inner surface of the second annular wall mates with the annular threaded metal insert, and the threaded metal insert mates with the threaded portion of the CTA conduit's top end.

23. The filter assembly of claim 10, wherein the bowl is unitary and made from a Fatigue Rated Glass Filled Plastic material.

24. The filter assembly of claim 10, wherein the bowl includes integral interior structural ribs located at the semi-closed base.

25. The filter assembly of claim 10, wherein the head includes a bypass valve.

26. The filter assembly of claim 10, wherein the head includes integral threaded ports for mounting at least one device selected from the group consisting of a differential pressure indicator, a bypass valve, a flow meter, and a temperature gauge.

27. A filter assembly comprising:
a filter element having an inlet side, an outlet side, a top end, a bottom end, and a filtration medium extending between said top and bottom ends and separating said inlet side from said outlet side, wherein the filter element is cylindrical and defines a longitudinal hollow center portion therethrough;
a center tube assembly (CTA) having a base and a central flow passage, said flow passage including a longitudinal conduit having a plurality of fluid flow perforations through the periphery thereof, and said base including an upper surface, a lower surface, and a radial, axially-extending protrusion that is formed as a knife-edge on said upper surface; and
an end cap coupled to the filter element's bottom end, wherein the end cap has a first surface that forms a seal with said bottom end such that the end cap is unitary with the bottom end and a second surface opposite to said first surface, said second surface having first and second radial, axially-extending protrusions to form a recessed pocket therebetween, said pocket being configured to form a fluid-tight seal with the CTA's knife edge.

28. The filter assembly of claim 27, wherein the filter element's top end is closed off with a solid cap, and the CTA's longitudinal conduit is attached, at one end, to the CTA's base and, at an opposite end, to a spring member such that, when the CTA is inserted into the filter element's hollow center portion and the spring member is pressed against said solid cap, the knife edge on the upper surface of the CTA's base matingly engages the end cap's recessed pocket so as to form a fluid-tight seal between the filter element and the CTA.

29. The filter assembly of claim 27, wherein the end cap is a poly-elastomeric annular disc.

30. The filter assembly of claim 27, wherein the filtration medium is a pleated membrane.

31. The filter element of claim 30, wherein the poly-elastomeric annular disc is formed from a poly-elastomeric compound in a molding operation in which the compound attaches to the pleats of the membrane so as to become unitary with the filter element.

32. The filter element of claim 27, wherein the poly-elastomeric annular disc is made from a viscoelastic polyurethane to form a viscoelastic-knife edge seal (VEKE-Seal).

33. The filter assembly of claim 27, wherein the filter element is configured to be contained in a housing, and the CTA's base includes a radial seal for sealingly engaging a radially outer surface of said base with said housing.

34. The filter assembly of claim 33, wherein said housing includes a base, at least one lateral fluid inlet passage, and a fluid outlet passage through said base.

35. The filter assembly of claim 34, wherein the housing has an open upper end configured to be coupled to a cover member.
